(19) United States
(12) Patent Application Publication
(10) Pub. No.: US 2022/0132322 A1
(43) Pub. Date: Apr. 28, 2022

(54) SELECTING AN OPERATING MODE

(71) Applicant: Nokia Technologies Oy, Espoo (FI)

(72) Inventor: Antti-Veikko Sakari PIIPPONEN, Helsinki (FI)

(21) Appl. No.: 17/430,932

(22) PCT Filed: Feb. 15, 2019
(86) PCT No.: PCT/EP2019/053779

§ 371 Date: Aug. 13, 2021

(51) Int. Cl. H04W 16/14

(52) U.S. Cl. CPC H04W 16/14

(57) ABSTRACT

An apparatus, method and computer program product for: providing an operating channel for accessing a first network, monitoring co-existence of a second network on the operating channel, and selecting an operating mode for the operating channel based upon whether coexistence of the second network is detected on the operating channel.

### TECHNICAL FIELD

The present application relates generally to selecting an operating mode. More specifically, the present application relates independently selecting an operating mode.

### BACKGROUND

Wireless networks are designed to support a wide range of spectrum bands. The spectrum can be categorised into a licensed spectrum and an unlicensed spectrum. The licensed spectrum is assigned exclusively to operators for independent usage while the unlicensed spectrum is assigned to every user for non-exclusive usage.

### SUMMARY

Various aspects of examples of the invention are set out in the claims.

According to a first aspect of the invention, there is provided an apparatus comprising means for performing: providing an operating channel for accessing a first network, monitoring co-existence of a second network on the operating channel and selecting an operating mode for the operating channel based upon whether co-existence of the second network is detected on the operating channel.

According to a second aspect of the invention, there is provided a method comprising: providing an operating channel for accessing a first network, monitoring co-existence of a second network on the operating channel and selecting an operating mode for the operating channel based upon whether co-existence of the second network is detected on the operating channel.

According to a third aspect of the invention, there is provided a computer program comprising instructions for causing an apparatus to perform at least the following: providing an operating channel for accessing a first network, monitoring co-existence of a second network on the operating channel and selecting an operating mode for the operating channel based upon whether co-existence of the second network is detected on the operating channel.

According to a fourth aspect of the invention, there is provided an apparatus comprising at least one processor and at least one memory including computer program code, the at least one memory and the computer program code configured to with the at least one processor, cause the apparatus at least to perform: provide an operating channel for accessing a first network, monitor co-existence of a second network on the operating channel and select an operating mode for the operating channel based upon whether co-existence of the second network is detected on the operating channel.

According to a fifth aspect of the invention, there is provided a non-transitory computer readable medium comprising program instructions for causing an apparatus to perform at least the following: providing an operating channel for accessing a first network, monitoring co-existence of a second network on the operating channel and selecting an operating mode for the operating channel based upon whether co-existence of the second network is detected on the operating channel.

According to a sixth aspect of the invention, there is provided a computer readable medium comprising program instructions for causing an apparatus to perform at least the following: providing an operating channel for accessing a first network, monitoring co-existence of a second network on the operating channel and selecting an operating mode for the operating channel based upon whether co-existence of the second network is detected on the operating channel.

### BRIEF DESCRIPTION OF THE DRAWINGS

For a more complete understanding of example embodiments of the present invention, reference is now made to the following descriptions taken in connection with the accompanying drawings in which:

FIG. 1 shows a part of an exemplifying radio access network in which examples of disclosed embodiments may be applied;

FIG. 2 shows a block diagram of an example apparatus in which examples of the disclosed embodiments may be applied;

FIG. 3 illustrates an example method incorporating aspects of the examples of the invention;

FIG. 4 illustrates another example method incorporating aspects of the examples of the invention;

FIG. 5 shows a block diagram of co-existence of a second network on an operating channel incorporating aspects of the examples of the invention;

FIG. 6 illustrates a further example method incorporating aspects of the examples of the invention.

### DETAILED DESCRIPTION OF THE DRAWINGS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Example embodiments relate to providing an operating channel for accessing a first network, monitoring co-existence of a second network on the operating channel and selecting an operating mode for the operating channel based upon whether co-existence of the second network is detected on the operating channel. Example embodiments further relate to providing an operating channel for accessing a first network and providing a first radio beam and a second radio beam on the operating channel. Example embodiments further relate to monitoring co-existence of a second network in a direction of the first radio beam and the second radio beam independently and selecting an operating mode for the first radio beam and the second radio beam independently. In an example embodiment, selecting an operating mode for the first radio beam and the second radio beam independently comprises selecting an operating mode based on whether co-existence of the second network is detected on the operating channel in the direction of the respective radio beam.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used not only for signalling purposes but also for routing data from one (e/g)NodeB to another. The (e/g)NodeB is a computing device configured to control the radio resources of communication system it is coupled to. The NodeB may also be referred to as a base station, an access point, an access node, or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilise cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

A wireless device is a generic term that encompasses both the access node and the terminal device.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being integradable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low-latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilise services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of functions between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or node B (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway, maritime, and/or aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

As commonly known in connection with wireless communication systems, control or management information is transferred over a radio interface, e.g. between the terminal device 100 and the access node 104.

5G New Radio (NR) networks are designed to support a wide range of frequency spectrum bands. The spectrum can be categorised into a licensed spectrum and an unlicensed spectrum. The licensed spectrum is assigned exclusively to operators for independent usage while the unlicensed spectrum is assigned to every user for non-exclusive usage. In other words, operating on an unlicensed spectrum is subject to interference of other users on a shared frequency band.

Due to interference issues on the unlicensed spectrum, channel access for an unlicensed spectrum operation typically uses different co-existence methods to enable co-existence with other devices on the same frequency band. An example of a co-existence method is, for example, a Listen-Before-Talk (LBT) protocol for sharing the unlicensed spectrum with other devices. The LBT protocol specifies that a device does not transmit on a channel that is occupied by some other device. Another example of avoiding interference is frequency hopping. Frequency hopping enables finding unused channels and not using channels that are in heavy use.

One possibility to try to improve co-existence is using radio beams. Wireless networks are configured to transmit data through radio beams. A radio beam provides an operating channel for transmitting data between a user equipment and a base station such as a gNodeB. A beam may be formed, for example, by a phased array antenna. The term beamforming refers to formation of a beam of energy from a set of phased arrays of antennas. In beamforming, the transmissions are directed to a specific user equipment for improved gain and reduced interference to users in neighbouring cells. The shape and direction of the signal beam from multiple antennas may be controlled based on the spacing of antenna elements and the phase of signal from each antenna element in the array. Beamforming allows individual users/devices to have an individual beam directed at them. The direction of the beam may be changed by altering the phase and/or the amplitude of the signals applied to the individual antenna elements. Beamforming also enables reducing interference, and thereby improving co-existence, by suppressing specific interfering signals, such as signals meant for some other user equipment.

However, current co-existence mechanisms still have some challenges. For example, in case two access points are mounted in a same location (e.g. in the same mast) and they serve different users in the same direction (e.g. within the same beam), if one of them uses LBT and the other one does not, a consequence may be that the one not using LBT occupies the channel and the one using LBT is completely blocked out.

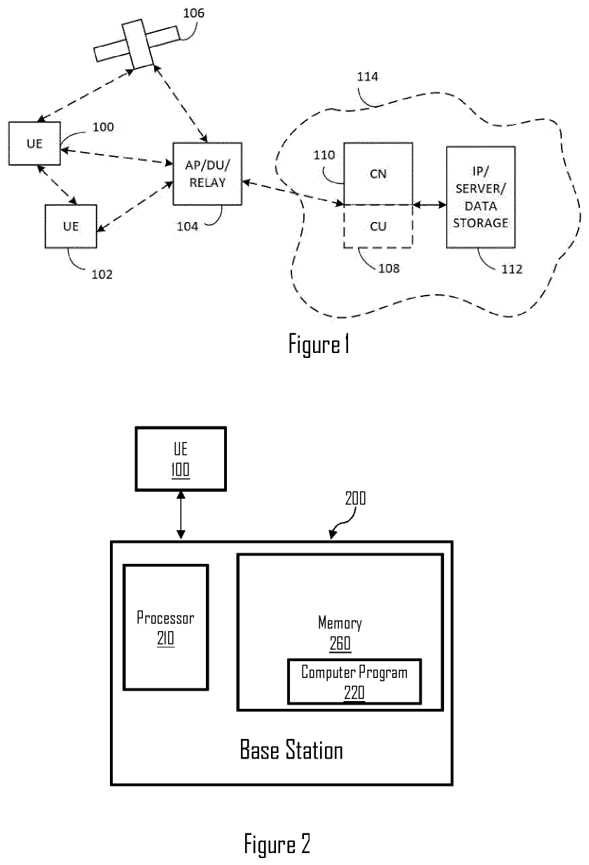

The example of FIG. 2 shows an exemplifying apparatus.

FIG. 2 is a block diagram depicting the apparatus 200 operating in accordance with an example embodiment of the invention. The apparatus 200 may be, for example, an electronic device such as a chip, chip-set or an access node such as a base station. In the example of FIG. 2, the apparatus 200 is a base station such as an eNodeB or gNodeB configured to communicate with a user equipment (UE) 100. The apparatus 200 includes a processor 210 and a memory 260. In other examples, the apparatus 200 may comprise multiple processors.

In the example of FIG. 2, the processor 210 is a control unit operatively connected to read from and write to the memory 260. The processor 210 may also be configured to receive control signals received via an input interface and/or the processor 210 may be configured to output control signals via an output interface. In an example embodiment the processor 210 may be configured to convert the received control signals into appropriate commands for controlling functionalities of the apparatus.

The memory 260 stores computer program instructions 220 which when loaded into the processor 210 control the operation of the apparatus 200 as explained below. In other examples, the apparatus 200 may comprise more than one memory 260 or different kinds of storage devices.

Computer program instructions 220 for enabling implementations of example embodiments of the invention or a part of such computer program instructions may be loaded onto the apparatus 200 by the manufacturer of the apparatus 200, by a user of the apparatus 200, or by the apparatus 200 itself based on a download program, or the instructions can be pushed to the apparatus 200 by an external device. The computer program instructions may arrive at the apparatus 200 via an electromagnetic carrier signal or be copied from a physical entity such as a computer program product, a memory device or a record medium such as a Compact Disc (CD), a Compact Disc Read-Only Memory (CD-ROM), a Digital Versatile Disk (DVD) or a Blu-ray disk.

According to an example embodiment, the apparatus 200 is configured to provide an operating channel for accessing a first network in a cell or coverage area managed by the apparatus 200.

The apparatus 200 is configured to provide the operating channel on a particular frequency spectrum. The frequency spectrum may comprise a licensed spectrum or an unlicensed spectrum. According to an example embodiment, the apparatus 200 is configured to provide the operating channel on an unlicensed spectrum. According to an example embodiment, the unlicensed spectrum comprises 60 GHz frequency band. The 60 GHz band may comprise different frequency bands in different parts of the world. For example, in Europe the 60 GHz frequency band may comprise 57-66 GHz, and in the US the 60 GHz frequency band may comprise 57-71 GHz. The unlicensed spectrum may also comprise other frequency bands such as a frequency band above or below 60 GHz, 28 GHz, 70 GHz or, for example 57-64 GHz or 30-300 GHz band.

A first network may be a network that is provided by the apparatus 200 or a network to which the apparatus 200 belongs. According to an example embodiment, the apparatus 200 comprises a base station such as gNodeB. The base station in FIG. 2 is configured to communicate with user equipment 100. User equipment 100 may be an electronic device such as a hand-portable device, a mobile phone or a Personal Digital Assistant (PDA), a Personal Computer (PC), a laptop, a desktop, a tablet computer, a wireless terminal, a communication terminal, a game console, a music player, an electronic book reader (e-book reader), a positioning device, a digital camera, a household appliance, a CD-, DVD or Blu-ray player, or a media player.

The apparatus 200 is further configured to monitor co-existence of a second network on the operating channel. Monitoring may comprise, for example, scanning the operating channel to detect devices and/or networks that do not belong to the same network as the apparatus 200. Monitoring co-existence of the second network may be performed, for example, in response to power-up of the apparatus 200 and/or in response to an indication that a new operating channel is taken into use. Monitoring may also be performed continuously or discontinuously, for example, at set time intervals.

Monitoring may comprise measuring energy on the operating channel and comparing an energy measurement to a threshold value. The threshold value may comprise, for example, a value describing a long-term average of noise on the operating channel together with interference and with a margin value. The energy measurement may also be frequency dependent. In such an example, the energy may be measured on an operating channel for a subcarrier and the measurement may be compared with frequency domain characteristics of a known system.

Monitoring may also be based on detecting a signal sequence such as a known signal sequence. For example, 802.11 based technologies typically use fixed preamble sequences for burst detection and time synchronization. As another example, known synchronization sequences may be detected. For example, 3GPP technologies use Primary Synchronization Signal (PSS) and Secondary Synchronization Signal (SSS) which can be detected during monitoring.

As another example, monitoring may be based on monitoring a difference between a theoretical and actual value. Monitoring may also comprise monitoring an error rate or a change in an error rate on an operating channel. A change in an error rate may be detected based on a comparison of an error value to a threshold error value. For example, the difference between a link bit/packet/block theoretical error rate and an actual error rate may be monitored. As another example, in 3GPP technologies, the Modulation and Coding Scheme (MCS) is set according to the received signal quality reported by the user equipment or measured by the base station. An example target value may be, for example, an error ratio of 5% or 10%. If a higher block error ratio (BLER) is received even though conditions are not changed, it may be an indication of a second network. The conditions may include transmit power, MCS and/or path loss. In this situation, HARQ ACK/NACK may be used for detecting. Monitoring may comprise receiving information on a detected second network form user equipment 100. For example, user equipment may detect a second network based on a narrow band or wideband Channel Quality Indicator (QCI) report.

According to an example embodiment, the apparatus 200 is configured to mark, in response to monitoring co-existence of a second network on an operating channel, the operating channel as free if a second network is not detected or occupied if a second network is detected.

According to an example embodiment, the second network is an interfering network. An interfering network comprises a network different from the network of the apparatus 200. An interfering network may comprise a network that occupies the same frequency band as the first operating channel and/or the second operating channel.

The apparatus 200 is further configured to select an operating mode for the operating channel based upon whether co-existence of the second network is detected on the operating channel. In other words, if a second network is detected on the operating channel, a suitable operating mode for the operating channel may be selected. On the other hand, if a second network is not detected on the operating channel, a current operating mode may be kept or monitoring co-existence of a second network may be continued.

According to an example embodiment, selecting an operating mode comprises selecting a co-existence mode for the operating channel, if co-existence of a second network is detected on the operating channel. A co-existence mode comprises a mode enabling co-existence with other devices on the same frequency band using a co-existence mechanism. In case multiple channels are provided by the apparatus 200, an operating mode may be selected for each channel independently.

According to an example embodiment, the apparatus 200 is further configured to provide a first radio beam and a second radio beam on the operating channel. The first radio beam and the second radio beam may be provided by an antenna comprised by the apparatus 200 or an antenna that is controlled by the apparatus 200. The antenna may be, for example, a directive antenna or a phased array antenna with beamforming. According to an example embodiment, the apparatus 200 comprises a phased array antenna. According to another example embodiment, the antenna is operatively connected to the apparatus 200.

Monitoring co-existence of a second network may comprise beam-based monitoring. In an example embodiment, monitoring co-existence of the second network comprises monitoring co-existence of the second network in a direction of the first radio beam and the second radio beam independently. In other words, monitoring the first radio beam may be performed independently of monitoring the second radio beam. A second network may be detected, for example, based on measured energy on a beam. Excess energy may be an indication of presence of other devices. However, different monitoring methods may be used, as explained above.

According to an example embodiment, monitoring co-existence of a second network is performed during radio beam sweeping, beam correspondence and/or measuring a beam during its receive time interval of the apparatus 200. Beam sweeping comprises transmitting radio beams in predefined directions in a burst in a regular interval. Beam correspondence comprises beam sweeping and monitoring user equipment responses. In an example embodiment, monitoring is performed during a receive phase in beam correspondence.

According to an example embodiment, the apparatus 200 is configured to select an operating mode for the first radio beam and the second radio beam independently. The apparatus 200 is configured to select an operating mode for the first radio beam and the second radio beam independently based upon whether co-existence of the second network is detected on the operating channel in the direction of the respective radio beam. In other words, the operating mode for the first radio beam may be selected independently of the operating mode of the second radio beam. Similarly, the operating mode for the second radio beam may be selected independently of the operating mode for the first radio beam. For example, if the second network is detected in the direction of the first radio beam, a suitable operating mode is selected for the first radio beam. Similarly, if the second network is detected in the direction of the second radio beam, a suitable operating mode is selected for the second radio beam. Hence, selecting an operating mode for the first radio beam does not require selecting/switching an operating mode for the second radio beam and selecting an operating mode for the second radio beam does not require selecting/switching an operating mode for the first radio beam. In other words, the apparatus 200 is configured to select an operating mode individually for each radio beam.

As explained above selecting an operating mode may be channel-based or beam-based. Selecting an operating mode may comprise entering an operating mode, switching an operating mode to another operating mode, initiating an operating mode, ending an operating mode or keeping the operating mode that is active at the time of detecting co-existence of a second network. Selecting an operating mode may further comprise continuing monitoring co-existence of a second network.

According to another example embodiment, selecting an operating mode comprises selecting a co-existence mode for the first radio beam, if co-existence of a second network is detected on the operating channel in the direction the first radio beam. Similarly, selecting comprises selecting a co-existence mode for the second radio beam, if co-existence of a second network is detected on the operating channel in the direction of the second radio beam.

According to a further example embodiment, selecting a co-existence mode comprises switching to another operating channel or using a listen-before-talk protocol.

According to an example embodiment, the operating mode selected for the first radio beam is different from the operating mode selected for the second radio beam. For example, the first radio beam may operate in a co-existence mode and the second radio beam may operate in an in-service monitoring mode. An in-service monitoring mode comprises monitoring an operating state of an operating channel. In an example embodiment, an in-service monitoring mode comprises monitoring whether other networks appear on the operating channel. According to an example embodiment, the first radio beam may be operated in a first operating mode concurrently with operating the second radio beam in a second operating mode.

According to an example embodiment, the apparatus 200 comprises means for performing, wherein the means for performing comprises at least one processor 210, at least one memory 260 including computer program code 220, the at least one memory 260 and the computer program code 220 configured to, with the at least one processor 210, cause the performance of the apparatus 200.

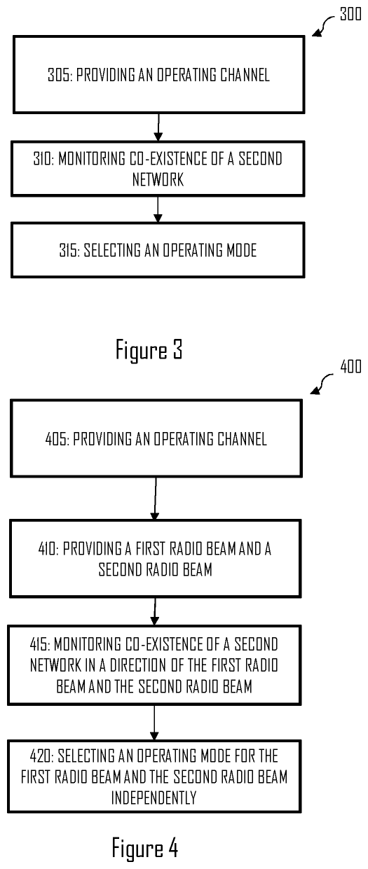

FIG. 3 illustrates an example method 300 incorporating aspects of the previously disclosed embodiments. More specifically the example method 300 illustrates channel-based monitoring and selecting an operating mode for an operating channel.

The method starts with providing 305 an operating channel for accessing a first network. The method continues with monitoring 310 co-existence of a second network on the operating channel.

The method further continues with selecting 315 an operating mode for the operating channel based upon whether co-existence of the second network is detected on the respective operating channel.

FIG. 4 illustrates another example method 400 incorporating aspects of the previously disclosed embodiments. More specifically the example method 400 illustrates beam-based monitoring of co-existence of a second network and selecting an operating mode for a first radio beam and a second radio beam independently.

The method starts with providing 405 an operating channel for accessing to a first network. The method continues with providing 410 a first radio beam and a second radio beam. The first radio beam and the second radio beam are provided by, for example, a base station. The method further continues with monitoring 415 co-existence of a second network on the operating channel in a direction of the first radio beam and the second radio beam and selecting 420 an operating mode for the first radio beam and the second radio beam independently. For example, if a second network is detected on the operating channel in the direction of the first radio beam, a co-existence mode for the first radio beam may be selected. Similarly, if a second network is detected on the operating channel in the direction of the second radio beam, a co-existence mode for the second radio beam may be selected. On the other hand, if a second network is not detected on the operating channel in the direction of a radio beam, a corresponding beam may operate in in-service monitoring mode. In other words, the operating mode for the first radio beam may be selected independent of the operating mode of the second radio beam and the operating mode for the second radio beam may be selected independent of the operating mode of the first radio beam.

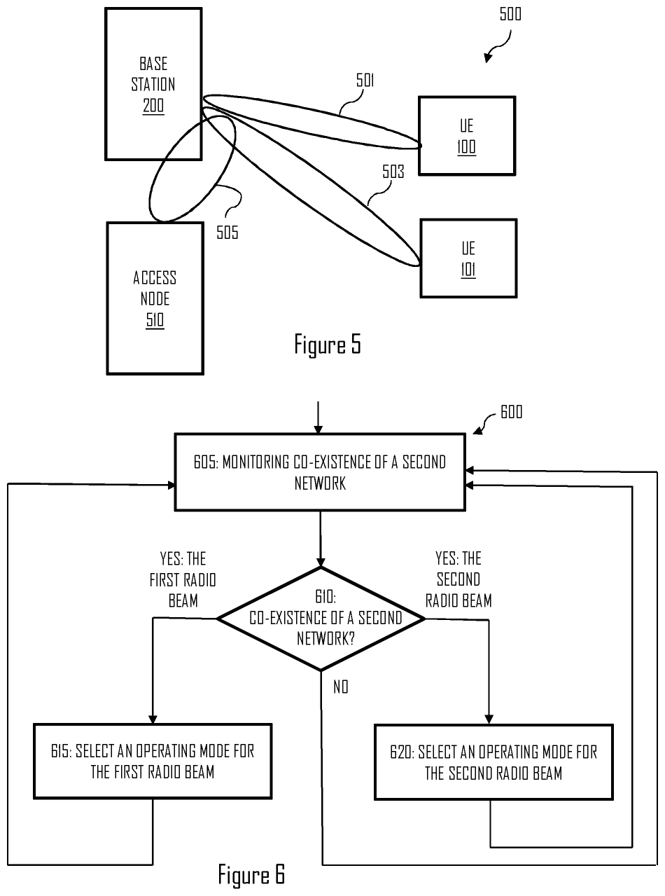

FIG. 5 is a block diagram 500 illustrating co-existence of a second network on a radio beam according to an example embodiment of the invention. In the example of FIG. 5, the apparatus 200 is an access node such as a base station, similar to the access node 104 in FIG. 1. A base station may be, for example, a gNodeB.

The apparatus 200 is configured to provide an operating channel for for user equipment 100, 101 for accessing a first network. The operating channel is provided on an unlicensed spectrum and, in this example embodiment, comprises 60 GHz frequency band. The first network may be, for example, a network provided by the apparatus 200 or a network that the apparatus 200 belongs to.

The apparatus 200 is further configured to provide a first radio beam 501 and a second radio beam 503.

FIG. 5 further illustrates an access node 510 providing a second network 505 that co-exists on the operating channel in the direction of the second radio beam 503. In a situation presented in FIG. 5, the co-existence of the second network on the second radio beam is detected and an operating mode for the second radio beam is selected. The operating mode for the second radio beam 503 may be selected independently of the operating mode for the first radio beam 501. In other words, selecting an operating mode for the second radio beam 503 does not require selecting the operating mode for the first radio beam 501 and selecting an operating mode for the first radio beam 501 does not require selecting the operating mode for the second radio beam 503.

According to an example embodiment, the apparatus 200 is configured, in a situation illustrated in FIG. 5, to select an operating mode for the second radio beam due to the detected co-existence of the second network. The operating mode may be, for example, a co-existence mode and selecting the co-existence mode causes entering the co-existence mode. Meanwhile, the operating mode for the first radio beam 501 may be kept as it is, or some other suitable mode may be selected for that. For example, assuming the first radio beam 501 is operating in an in-service monitoring mode when co-existence of the second network is detected, the first radio beam 501 may continue operating in the in-service monitoring mode.

FIG. 6 illustrates a further example method 600 incorporating aspects of the previously disclosed embodiments. More specifically, the example method illustrates monitoring co-existence of a second network and selecting an operating mode for a radio beam. In this method it is assumed that a first radio beam and a second radio beam for accessing a first network are provided by, for example, a base station.

The method starts with monitoring 605 co-existence of a second network on an operating channel in the direction of the first radio beam and the second radio beam. The method continues with determining 610 whether co-existence of the second network is detected on the operating channel in a direction of the first radio beam and/or the second radio beam. If co-existence of the second network is not detected in the direction of either radio beam, the method continues with monitoring 605 co-existence of a second network. If it is detected that a second network co-exists in the direction of the first radio beam, an operating mode is selected 615 for the first radio beam. After that the method continues with monitoring 605 co-existence of a second network. If it is detected that a second network co-exists in the direction of the second radio beam, an operating mode is selected 620 for the second radio beam. After that the method continues with monitoring 605 co-existence of a second network. Selecting an operating mode may comprise, for example, entering a co-existence mode.

It should be noted, that co-existence of a second network may be detected in a direction of both the first and the second operating channel and, as a consequence, a first operating mode may be selected for the first radio beam and a second operating mode may be selected for the second radio beam. The operating mode selected for the first radio beam may be different from the operating mode selected for the second radio beam. Alternatively, the operating mode selected for the first radio beam may be the same as the operating mode selected for the second radio beam.

Without limiting the scope of the claims, an advantage of selecting an operating mode independently for each radio beam is that a base station may operate simultaneously in multiple different modes and enable co-existence between users.

Without in any way limiting the scope, interpretation, or application of the claims appearing below, a technical effect of one or more of the example embodiments disclosed herein is that more efficient spectrum sharing is enabled with selecting an operating mode for a radio beam independent of an operating mode of any other radio beam.

Embodiments of the present invention may be implemented in software, hardware, application logic or a combination of software, hardware and application logic. The software, application logic and/or hardware may reside on the apparatus, a separate device or a plurality of devices. If desired, part of the software, application logic and/or hardware may reside on the apparatus, part of the software, application logic and/or hardware may reside on a separate device, and part of the software, application logic and/or hardware may reside on a plurality of devices. In an example embodiment, the application logic, software or an instruction set is maintained on any one of various conventional computer-readable media. In the context of this document, a ‘computer-readable medium’ may be any media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It will be obvious to a person skilled in the art that, as the technology advances, the inventive concept can be implemented in various ways. The invention and its embodiments are not limited to the examples described above but may vary within the scope of the claims.

1-17. (canceled)

18. An apparatus comprising at least one processor, at least one memory including computer program code, the at least memory and the computer program code configured to, with the at least one processor, cause the apparatus to:
provide an operating channel for accessing a first network;
monitor co-existence of a second network on the operating channel; and
select an operating mode for the operating channel based upon whether co-existence of the second network is detected on the operating channel.

19. The apparatus according to claim 18, wherein the at least memory and the computer program code further configured to, with the at least one processor, cause the apparatus to provide a first radio beam and a second radio beam on the operating channel.

20. The apparatus according to claim 19, wherein the at least memory and the computer program code further configured to, with the at least one processor, cause the apparatus to monitor co-existence of the second network in a direction of the first radio beam and the second radio beam independently.

21. The apparatus according to claim 19, wherein the at least memory and the computer program code further configured to, with the at least one processor, cause the apparatus to select an operating mode for the first radio beam and an operating mode for the second radio beam, independently.

22. The apparatus according to claim 19, wherein the operating mode selected for the first radio beam is different from the operating mode selected for the second radio beam.

23. The apparatus according to claim 19, wherein the at least memory and the computer program code further configured to, with the at least one processor, cause the apparatus to select a co-existence mode for the first radio beam, if co-existence of the second network is detected on the first radio beam.

24. The apparatus according to claim 18, wherein the at least memory and the computer program code further configured to, with the at least one processor, cause the apparatus to select a co-existence mode for the operating channel, if co-existence of the second network is detected on the operating channel.

25. The apparatus according to claim 24, wherein the at least memory and the computer program code further configured to, with the at least one processor, cause the apparatus to switch to another operating channel or using listen-before-talk protocol.

26. The apparatus according to claim 18, wherein the at least memory and the computer program code further configured to, with the at least one processor, cause the apparatus to provide the operating channel on an unlicensed spectrum, and
wherein the unlicensed spectrum comprises 60 GHz frequency band.

27. The apparatus according to claim 18, wherein the at least memory and the computer program code further configured to, with the at least one processor, cause the apparatus to monitor co-existence of the second network during radio beam sweeping or during receive intervals of the apparatus.

28. The apparatus according to claim 18, wherein the at least memory and the computer program code further configured to, with the at least one processor, cause the apparatus to monitor an error rate and/or a change in an error rate on the operating channel.

29. The apparatus according to claim 18, wherein the apparatus comprises a base station, and wherein the apparatus comprises a phased array antenna.

30. A method comprising:
providing an operating channel for accessing a first network;
monitoring co-existence of a second network on the operating channel; and
selecting an operating mode for the operating channel based upon whether co-existence of the second network is detected on the operating channel.

31. The method according to claim 30, further comprising:
providing a first radio beam and a second radio beam on the operating channel.

32. The method according to claim 31, wherein the monitoring co-existence of the second network on the operating channel comprises monitoring co-existence of the second network in a direction of the first radio beam and the second radio beam independently.

33. The method according to claim 31, wherein selecting the operating mode for the operating channel comprises selecting an operating mode for the first radio beam and an operating mode for the second radio beam, independently.

34. The method according to claim 31, wherein the operating mode selected for the first radio beam is different from the operating mode selected for the second radio beam.

35. The method according to claim 31, wherein selecting the operating mode comprises selecting a co-existence mode for the first radio beam, if co-existence of the second network is detected on the first radio beam.

36. The method according to claim 31, wherein selecting the operating mode comprises selecting a co-existence mode for the operating channel, if co-existence of the second network is detected on the operating channel.

37. A computer program comprising instructions for causing an apparatus to perform at least the following:
providing an operating channel for accessing a first network;
monitoring co-existence of a second network on the operating channel; and
selecting an operating mode for the operating channel based upon whether co-existence of the second network is detected on the operating channel.
